(19) United States
(12) Patent Application Publication
(10) Pub. No.: US 2026/0059577 A1
(43) Pub. Date: Feb. 26, 2026

(54) APPLICATION OF TIMING ADVANCE COMMANDS OF AN ACCESS CHANNEL MESSAGE TO A TIMING ADVANCE GROUP OF MULTIPLE TIMING ADVANCE GROUPS

(71) Applicant: QUALCOMM Incorporated, San Diego, CA (US)

(72) Inventors: Shaozhen GUO, Beijing (CN); Mostafa KHOSHNEVISAN, San Diego, CA (US); Yan ZHOU, San Diego, CA (US); Xiaoxia ZHANG, San Diego, CA (US)

(21) Appl. No.: 19/103,417

(22) PCT Filed: Sep. 30, 2022
(86) PCT No.: PCT/CN2022/123157

§ 371 Date: Feb. 12, 2025

(51) Int. Cl. H04W 74/0833; H04B 7/06; H04W 56/00

(52) U.S. Cl. CPC H04W 74/0833; H04B 7/06964; H04W 56/0045

(57) ABSTRACT

Various aspects of the present disclosure generally relate to wireless communication. In some aspects, a UE may receive an indication of a first Network TAG associated with a first wireless link and a second TAG associated with a Node Receive configuration information UE second wireless link for a serving cell. The UE may transmit a first RACH message based at least in part on a failure of a BFR procedure associated with at least one of a first BFD-RS set associated with the first wireless link or a second BFD-Receive RS set associated with the second wireless link. The UE may receive, based at least in part on transmitting the first RACH message, a second RACH message that indicates a TAC for the serving cell. The UE may communicate, with the serving cell, based at least in part on application of the TAC to the first TAG or the second TAG.

### FIELD OF THE DISCLOSURE

Aspects of the present disclosure generally relate to wireless communication and specifically, to techniques and apparatuses for application of timing advanced commands of an access channel message to a timing advance group (TAG) of multiple TAGs.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some networks, a UE may communicate with a network node via multiple transmission reception points (TRPs). For example, the UE may communicate with the network node via a first wireless link with a first TRP and a second wireless link with a second TRP. The first TRP may be associated with a first timing advance group (TAG) and the second TRP may be associated with a second TAG (for example, based at least in part on the first TRP and the first TAG being associated with a first control resource set (CORESET) pool index and the second TRP and the second TAG being associated with a second CORESET pool index). Timing advances (TAs) of the TAG may be candidates for selection to use in communications between the UE and the network node. For example, a TA of the first TAG may indicate an amount of time to shift uplink communications (e.g., shifting earlier) relative to a timing event associated with downlink communications. The UE may use the TA to transmit an uplink communication in instances in which the TA is selected. In this way, the UE may shift timing of communications to account for propagation delays for signals traveling between the UE and the network node.

The UE may identify a beam failure (for example, based on identifying a beam failure detection (BFD) event) for one or more of the first wireless link or the second wireless link. Based at least in part on the beam failure, the UE may trigger a per-TRP beam failure recovery (BFR) procedure to re-establish the first wireless link or the second wireless link. If the BFR procedure fails, the UE may initiate a random access procedure.

In examples in which a per-TRP BFR procedure is employed, a respective BFD reference signal (RS) set, a respective new beam identification RS (NBI-RS) set, and a respective BFD count and respective timer are associated with respective ones of the first TRP and the second TRP. In examples in which a serving cell (for example, a special cell (SpCell)) is configured with two BFD-RS sets and in instances in which all BFD-RS sets fail in the serving cell, the UE may trigger a contention-based random access (CBRA) procedure. In addition, in instances in which at least one of the BFD-RS sets fails, a physical uplink control channel (PUCCH) scheduling request (SR) is not configured, and no uplink grant is available, the UE may trigger a CBRA. During a random access procedure associated with the CBRA, the network node may transmit an indication of a timing advance command (TAC) to indicate a TA to use during or after the random access procedure.

### SUMMARY

Some aspects described herein relate to a method of wireless communication performed by a user equipment (UE). The method may include receiving an indication of a first timing advance group (TAG) associated with a first wireless link and a second TAG associated with a second wireless link for a serving cell. The method may include transmitting a first random access channel (RACH) message on the serving cell based at least in part on a failure of a beam failure recovery (BFR) procedure associated with at least one beam failure detection (BFD) reference signal (RS) set from among a first BFD-RS set associated with the first wireless link or a second BFD-RS set associated with the second wireless link. The method may include receiving, based at least in part on transmitting the first RACH message, a second RACH message that indicates a timing advance command (TAC) for the serving cell. The method may include communicating, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message; a BFD-RS set of the first BFD-RS set or the second BFD-RS set, that is not the at least one BFD-RS set, for which the BFR procedure is not triggered; or a synchronization signal block (SSB) associated with the first RACH message.

Some aspects described herein relate to a UE for wireless communication. The user equipment may include at least one processor and at least one memory, communicatively coupled with the at least one processor, that stores processor-readable code. The processor-readable code, when executed by the at least one processor, may be configured to cause the user equipment to receive an indication of a first TAG associated with a first wireless link and a second TAG associated with a second wireless link for a serving cell. The processor-readable code, when executed by the at least one processor, may be configured to cause the user equipment to transmit a first RACH message on the serving cell based at least in part on a failure of a BFR procedure associated with at least one BFD-RS set from among a first BFD-RS set associated with the first wireless link or a second BFD-RS set associated with the second wireless link. The processor-readable code, when executed by the at least one processor, may be configured to cause the user equipment to receive, based at least in part on transmitting the first RACH message, a second RACH message that indicates a TAC for the serving cell. The processor-readable code, when executed by the at least one processor, may be configured to cause the user equipment to communicate, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message; a BFD-RS set of the first BFD-RS set or the second BFD-RS set, that is not the at least one BFD-RS set, for which the BFR procedure is not triggered; or a SSB associated with the first RACH message.

Some aspects described herein relate to a non-transitory computer-readable medium that stores a set of instructions for wireless communication by a UE. The set of instructions, when executed by one or more processors of the UE, may cause the UE to receive an indication of a first TAG associated with a first wireless link and a second TAG associated with a second wireless link for a serving cell. The set of instructions, when executed by one or more processors of the UE, may cause the UE to transmit a first RACH message on the serving cell based at least in part on a failure of a BFR procedure associated with at least one BFD-RS set from among a first BFD-RS set associated with the first wireless link or a second BFD-RS set associated with the second wireless link. The set of instructions, when executed by one or more processors of the UE, may cause the UE to receive, based at least in part on transmitting the first RACH message, a second RACH message that indicates a TAC for the serving cell. The set of instructions, when executed by one or more processors of the UE, may cause the UE to communicate, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message; a BFD-RS set of the first BFD-RS set or the second BFD-RS set, that is not the at least one BFD-RS set, for which the BFR procedure is not triggered; or a SSB associated with the first RACH message.

Some aspects described herein relate to an apparatus for wireless communication. The apparatus may include means for receiving an indication of a first TAG associated with a first wireless link and a second TAG associated with a second wireless link for a serving cell. The apparatus may include means for transmitting a first RACH message on the serving cell based at least in part on a failure of a BFR procedure associated with at least one BFD-RS set from among a first BFD-RS set associated with the first wireless link or a second BFD-RS set associated with the second wireless link. The apparatus may include means for receiving, based at least in part on transmitting the first RACH message, a second RACH message that indicates a TAC for the serving cell. The apparatus may include means for communicating, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message; a BFD-RS set of the first BFD-RS set or the second BFD-RS set, that is not the at least one BFD-RS set, for which the BFR procedure is not triggered; or a SSB associated with the first RACH message.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a beam failure recovery procedure, in accordance with the present disclosure.

FIG. 5 is a diagram illustrating an example of a four-step random access procedure, in accordance with the present disclosure.

FIG. 6 is a diagram of an example associated with application of timing advance commands (TACs) of an access channel message to a timing advance group (TAG) of multiple TAGs, in accordance with the present disclosure.

FIG. 7 is a diagram illustrating an example of a four-step random access procedure, in accordance with the present disclosure.

FIG. 8 is a diagram illustrating an example of a four-step random access procedure, in accordance with the present disclosure.

FIG. 9 is a diagram illustrating an example of a four-step random access procedure, in accordance with the present disclosure.

FIG. 10 is a diagram illustrating an example of a four-step random access procedure, in accordance with the present disclosure.

FIG. 11 is a diagram illustrating an example of a four-step random access procedure, in accordance with the present disclosure.

FIG. 12 is a flowchart illustrating an example process performed, for example, by a UE that supports selection of a TAG, in a multi-TAG communication scheme, to which the UE is to apply a TAC received during a random access procedure, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to application of a timing advance command (TAC), indicated during a random access procedure, to a first timing advance group (TAG) or a second TAG. Some aspects more specifically relate to communicating based at least in part on application of the TAC to the first TAG or the second TAG in a multiple transmission reception point (TRP) scenario. In some aspects, a user equipment (UE) may initiate the random access procedure after failure of a beam failure recovery (BFR) procedure.

In some examples, the UE may apply the TAC to the first TAG based at least in part on failing to identify any new candidate beams for any new beam identification (NBI) reference signal (RS) set when transmitting a first random access message. For example, the UE may apply the TAC to the first TAG based at least in part on the first TAG being associated with a first TAG that is associated with a first TAG index, a lowest TAG identity relative to a second TAG identity associated with the second TAG, or associated with a default control resource set (CORESET) pool index, among other examples.

In some other examples, the UE may apply the TAC to the first TAG based at least in part on identifying a new candidate beam in an NBI-RS set when transmitting a first random access message. For example, the UE may apply the TAC to the first TAG based at least in part on the first TAG being associated with the NBI-RS set in which the UE identifies the new candidate beam.

In some other examples, the UE may apply the TAC to the first TAG based at least in part on the UE selecting a synchronization signal block (SSB) from an NBI-RS set associated with the first TAG.

In some aspects, the UE may identify a first new candidate beam in a first NBI-RS set associated with the first TAG and a second new candidate beam in a second NBI-RS set associated with the second TAG when transmitting a first random access message. For example, the UE may apply the TAC to the first TAG based at least in part on the first TAG being associated with the NBI-RS set to which a selected SSB belongs. The SSB may belong to the NBI-RS set based at least in part on being received on a beam within the NBI-RS set.

In some other examples, the UE may apply the TAC to the first TAG based at least in part on the BFR procedure not being triggered for a BFD-RS set associated with the first TAG. For example, the UE may apply the TAC to the first TAG based at least in part on the BFR procedure being triggered for a BFD-RS set associated with the second TAG.

In some other examples, the UE may apply the TAC to the first TAG based at least in part on a same CORESET pool index being associated with the first TAG and an SSB associated with the first random access message or the first TAG being associated with the SSB associated with the first random access message.

Particular aspects of the subject matter described in this disclosure can be implemented to realize one or more of the following potential advantages. In some examples, the described techniques can be used to synchronize, between the UE and the network node, application of a TAC to one of multiple TAGs, where the TAGs are associated with different TRPs or wireless links of a serving cell. In this way, the UE may apply the TAC to an intended TAG (for example, intended by the network node) for configuring timing of communications using the intended TAG and an associated communication link or beam. Based at least in part on applying the TAC to the intended TAG, the UE and the network node may have improved timing synchronization, reduced error rates, and improved spectral efficiency. In this way, the UE and the network node may conserve power, computing, network, and communication resources that may have otherwise been used to detect and correct errors associated with applying the TAC to an unintended TAG.

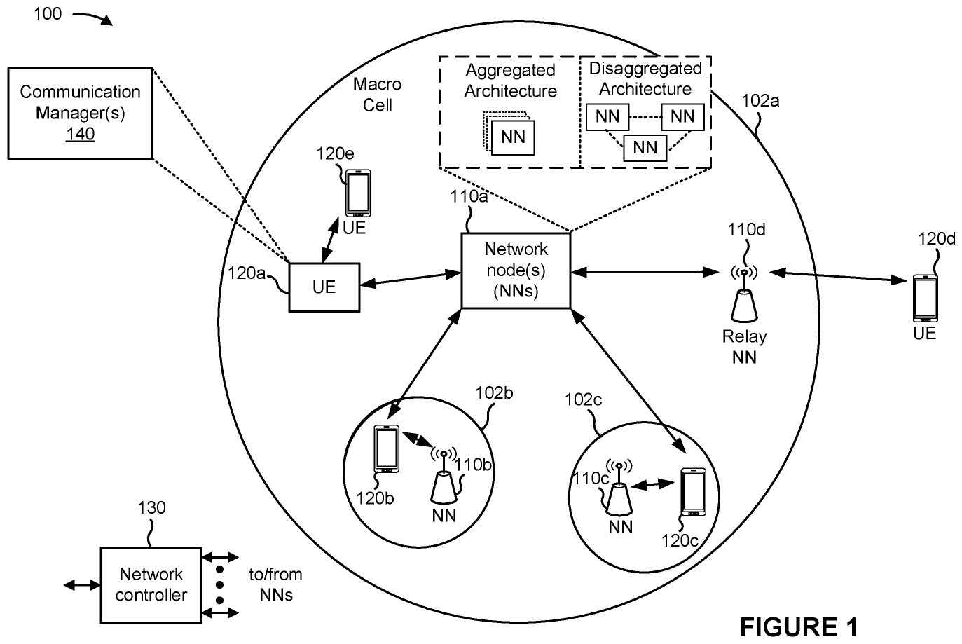

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave”band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication of a first TAG associated with a first wireless link and a second TAG associated with a second wireless link for a serving cell; transmit a first random access channel (RACH) message on the serving cell based at least in part on a failure of a BFR procedure associated with at least one beam failure detection (BFD) RS set from among a first BFD-RS set associated with the first wireless link or a second BFD-RS set associated with the second wireless link; receive, based at least in part on transmitting the first RACH message, a second RACH message that indicates a TAC for the serving cell; and communicate, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message. Additionally, or alternatively, the communication manager 140 may perform one or more other operations described herein.

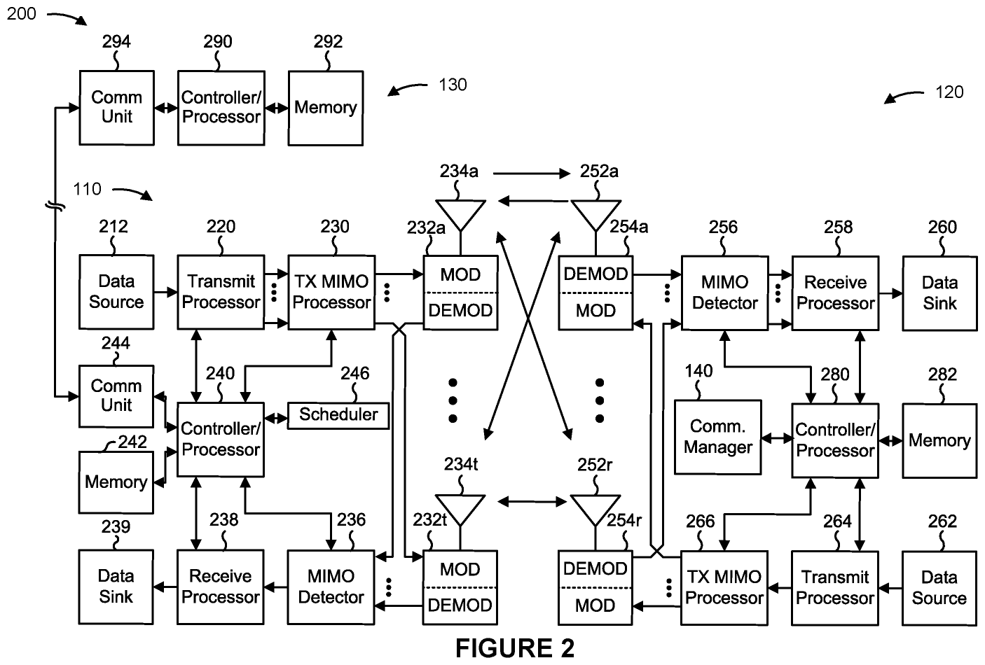

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

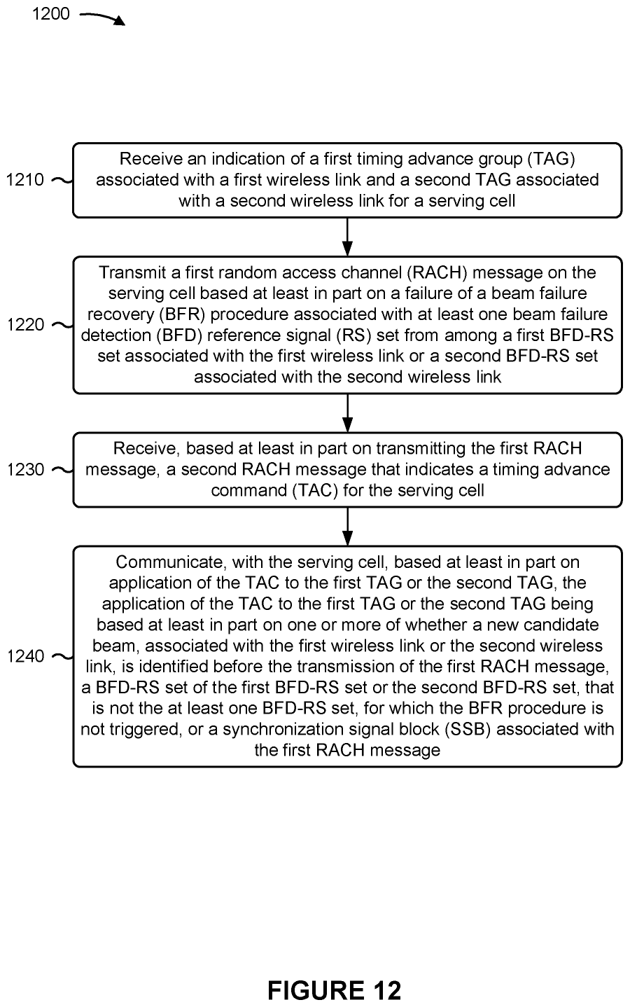

The controller/processor 240 of the network node 110, the controller/processor 280 of the UE 120, or any other component(s) of FIG. 2 may perform one or more techniques associated with application of TACs of an access channel message to a TAG of multiple TAGs, as described in more detail elsewhere herein. For example, the controller/processor 240 of the network node 110, the controller/processor 280 of the UE 120, or any other component(s) of FIG. 2 may perform or direct operations of, for example, process 1200 of FIG. 12, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1200 of FIG. 12, or other processes as described herein. In some examples, executing instructions may include running the instructions, converting the instructions, compiling the instructions, or interpreting the instructions, among other examples.

In some aspects, the UE includes means for receiving an indication of a first TAG associated with a first wireless link and a second TAG associated with a second wireless link for a serving cell; means for transmitting a first random access channel (RACH) message on the serving cell based at least in part on a failure of a BFR procedure associated with at least one BFD-RS set from among a first BFD-RS set associated with the first wireless link or a second BFD-RS set associated with the second wireless link; means for receiving, based at least in part on transmitting the first RACH message, a second RACH message that indicates a TAC for the serving cell; or means for communicating, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

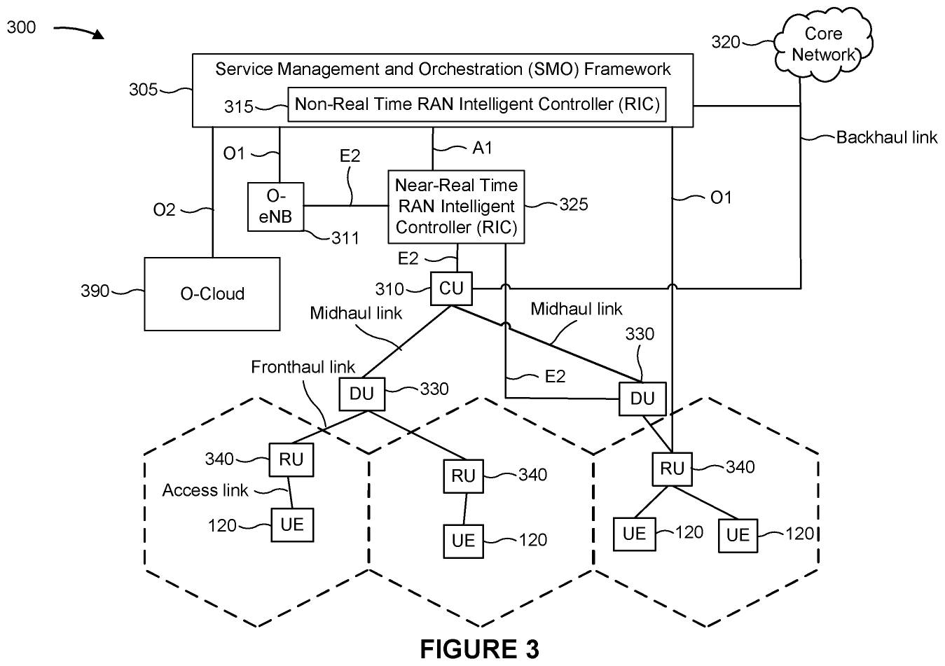

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

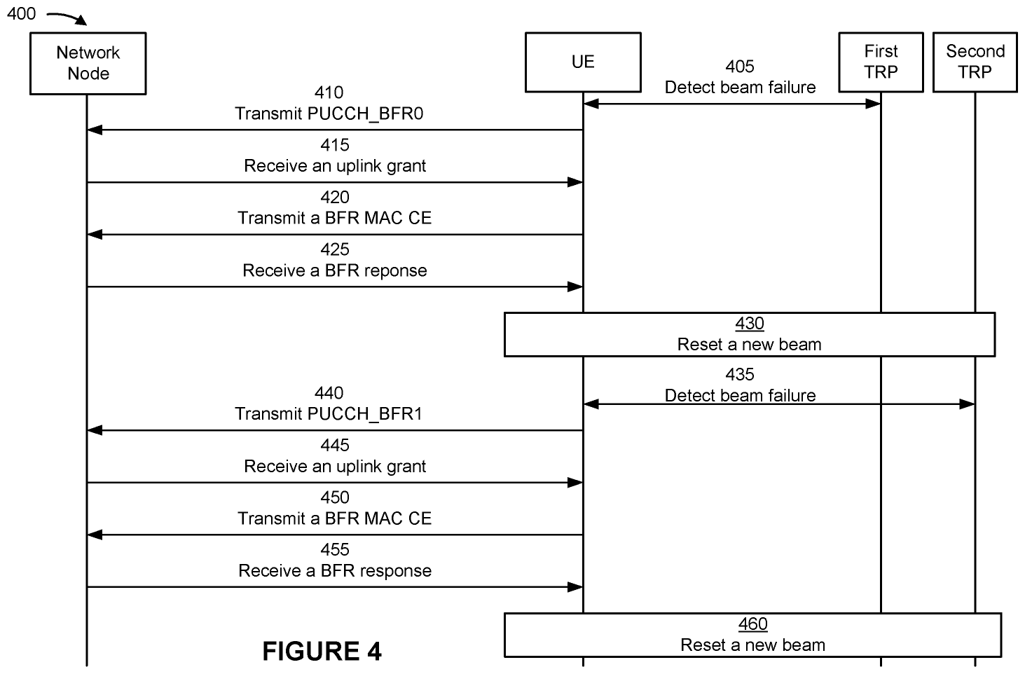

FIG. 4 is a diagram illustrating an example 400 of a beam failure recovery procedure in accordance with the present disclosure. As shown in FIG. 4, a UE may communicate with a network node (for example, associated with a primary cell), a first TRP associated with a first wireless link to a serving cell, and a second TRP associated with a second wireless link to the serving cell.

As shown in a first operation 405, the UE may detect a beam failure associated with the first TRP and the first wireless link. BFD may be a per-TRP operation. Associated BFD-RS sets, NBI-RS sets, BFD counts, and BFD timers may also be per-TPR (for example, TRP-specific).

In some examples, the UE may identify an implicit BFD-RS set for a multi-DCI communication scheme. For example, a BFD-RS set k (k=0, 1) may be derived based at least in part on X TCI of CORESETs with CORESETPoolIndex=k. If a number of CORESET TCI states per TRP exceeds a UE capability for a maximum number of BFD-RS resources per set, the UE may re-use a radio link monitoring (RLM) RS selection rule.

In some examples, the UE may identify an explicit BFD-RS set for a multi-DCI communication scheme. For example, the explicit BFD-RS set may be configured using radio resource control (RRC) signaling.

As shown in a second operation 410, the UE may transmit, and the network node may receive, a physical uplink control channel (PUCCH)-BFR indication associated with the first TRP (BFR_0). In some networks, the UE may select a PUCCH-BFR resource to use for transmitting the indication. For example, two PUCCH-BFR resources may be configured per PUCCH group. The UE may select a PUCCH-BFR resource associated with the first TRP (for example, a TRP associated with the BFD).

As shown in a third operation 415, the UE may receive, and the network node may transmit, an uplink grant. The uplink grant may provide a resource for the UE to use to transmit additional information in a medium access control (MAC) control element (CE).

As shown in a fourth operation 420, the UE may transmit a BFR MAC CE. The BFR MAC CE may carry a BFR request (BFRQ) for all TRPs in all component carriers in a cell group. The BFRQ may include indices of failed BFD-RS set (for example, as indications of failed TRP links), indices of component carriers containing the failed TRP link (for example, the TRP link having beam failure detected), an indication of whether a new candidate beam is identified in an NBI-RS set associated with a failed BFD-RS set, or a resource indicator associated with the new candidate beam (for example, if identified).

As shown in a fifth operation 425, the UE may receive, and the network node may transmit, a BFR response. The BFR response may include an uplink grant that schedules a subsequent transmission for a same hybrid automatic repeat request (HARQ) identifier as the BFR MAC CE.

As shown in a sixth operation 430, the UE may reset a new beam. For example, the UE and the first TRP may reset new beams for CORESETs of a CORESET pool index associated with the first TRP. In some networks, after 28 symbols from receiving the BFR response, the beams of all CORESETs associated with the CORESETPoolIndex associated with the first TRP (for example, a failed TRP) is reset to a corresponding new candidate beam as reported.

As shown in a seventh operation 435, the UE may detect a beam failure associated with the second TRP and the second wireless link. BFD may be a per-TRP operation. Associated BFD-RS sets, NBI-RS sets, BFD counts, and BFD timers may also be per-TPR (for example, TRP-specific).

In some examples, the UE may identify an implicit BFD-RS set for a multi-DCI communication scheme. For example, a BFD-RS set k (k=0, 1) may be derived based at least in part on X TCI of CORESETs with CORESETPoolIndex=k. If a number of CORESET TCI states per TRP exceeds a UE capability for a maximum number of BFD-RS resources per set, the UE may re-use a radio link monitoring (RLM) RS selection rule.

In some examples, the UE may identify an explicit BFD-RS set for a multi-DCI communication scheme. For example, the explicit BFD-RS set may be configured using RRC signaling.

As shown in an eighth operation 440, the UE may transmit, and the network node may receive, a PUCCH-BFR indication associated with the second TRP (BFR_1). In some networks, the UE may select a PUCCH-BFR resource to use for transmitting the indication. For example, two PUCCH_BFR resources may be configured per PUCCH group. The UE may select a PUCCH-BFR resource associated with the second TRP (for example, a TRP associated with the BFD).

As shown in a ninth operation 445, the UE may receive, and the network node may transmit, an uplink grant. The uplink grant may provide a resource for the UE to use to transmit additional information in a MAC CE.

As shown in a tenth operation 450, the UE may transmit a BFR MAC CE. The BFR MAC CE may carry a BFRQ for all TRPs in all component carriers in a cell group. The BFRQ may include indices of failed BFD-RS set (for example, as indications of failed TRP links), indices of component carriers containing the failed TRP link (for example, the TRP link having beam failure detected), an indication of whether a new candidate beam is identified in an NBI-RS set associated with a failed BFD-RS set, or a resource indicator associated with the new candidate beam (for example, if identified).

As shown in an eleventh operation 455, the UE may receive, and the network node may transmit, a BFR response. The BFR response may include an uplink grant that schedules a subsequent transmission for a same hybrid automatic repeat request (HARQ) identifier as the BFR MAC CE.

As shown in a twelfth operation 460, the UE may reset a new beam. For example, the UE and the second TRP may reset new beams for CORESETs of a CORESET pool index associated with the second TRP. In some networks, after 28 symbols from receiving the BFR response, the beams of all CORESETs associated with the CORESETPoolIndex associated with the second TRP (for example, a failed TRP) is reset to a corresponding new candidate beam as reported.

In some networks, if the serving cell is configured with two BFD-RS sets, if a BFR procedure is triggered for both BFD-RS sets of the serving cell (for example, a SpCell), and the BFR procedure is not successfully completed for any of the BFD-RS sets, the UE may initiate a random access procedure on the serving cell. Additionally, or alternatively, as long as at least one SR is pending, a MAC entity of the UE may, for each pending scheduling request, if the MAC entity has no valid PUCCH resource configured for the pending SR, the UE may initiate a random access procedure on the SpCell and cancel the pending SR.

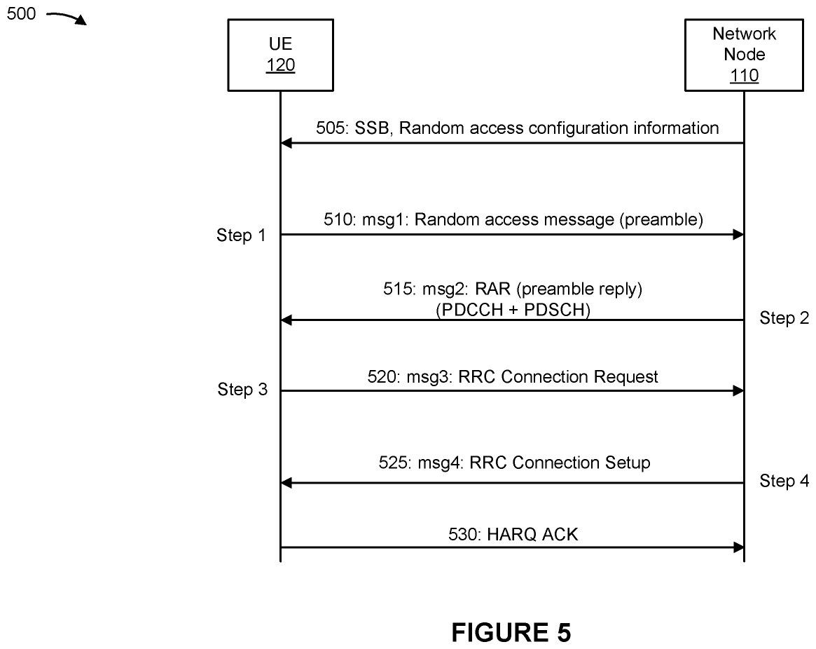

FIG. 5 is a diagram illustrating an example 500 of a four-step random access procedure, in accordance with the present disclosure. As shown in FIG. 5, a network node 110 and a UE 120 may communicate with one another to perform the four-step random access procedure.

As shown in a first operation 505, the network node 110 may transmit, and the UE 120 may receive, one or more SSBs and random access configuration information. In some aspects, the random access configuration information may be transmitted in or indicated by system information (for example, in one or more system information blocks (SIBs)) or an SSB, such as for contention-based random access. Additionally, or alternatively, the random access configuration information may be transmitted in a RRC message or a physical downlink control channel (PDCCH) order message that triggers a RACH procedure, such as for contention-free random access. The random access configuration information may include one or more parameters to be used in the random access procedure, such as one or more parameters for transmitting a RAM or one or more parameters for receiving an RAR.

As shown in a second operation 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a third operation 515, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fourth operation 520, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate for each TRP (for example, a first TRP and a second TRP) a failed BFR set identifier, an NBI existence, or an NBI.

As shown in a fifth operation 525, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a sixth operation 530, if the UE 120 successfully receives the RRC connection setup message, the UE 120 may transmit a HARQ ACK.

Based at least in part on the UE receiving the TAC in the msg2 and without an indication of which TAG to which the UE is to apply the TAC, the UE and the network node may be unsynchronized. This may cause the UE to apply the TAC to an unintended TAG, which may cause the UE and the network node to communicate with degraded timing synchronization, increased error rates, and reduced spectral efficiency. Additionally or alternatively, the UE and the network node may consume power, computing, network, and communication resources to detect and correct errors associated with applying the TAC to an unintended TAG.

Various aspects relate generally to application of a timing advance command TAC, indicated during a random access procedure, to a first TAG or a second TAG. Some aspects more specifically relate to communicating based at least in part on application of the TAC to the first TAG or the second TAG in a multiple transmission reception point TRP scenario. In some aspects, the UE may initiate the random access procedure after failure of a beam failure recovery BFR procedure.

In some aspects, the UE may apply the TAC to the first TAG based at least in part on failing to identify any new candidate beams for any NBIRS set when transmitting a first random access message. For example, the UE may apply the TAC to the first TAG based at least in part on the first TAG being associated with a first TAG that is associated with a first TAG index, a lowest TAG identity relative to a second TAG identity associated with the second TAG, or associated with a default CORESET pool index, among other examples.

In some aspects, the UE may apply the TAC to the first TAG based at least in part on identifying a new candidate beam in an NBI-RS set when transmitting a first random access message. For example, the UE may apply the TAC to the first TAG based at least in part on the first TAG being associated with the NBI-RS set in which the UE identifies the new candidate beam.

In some aspects, the UE may apply the TAC to the first TAG based at least in part on the UE selecting a SSB from an NBI-RS set associated with the first TAG. In some aspects, the UE may identify a first new candidate beam in a first NBI-RS set associated with the first TAG and a second new candidate beam in a second NBI-RS set associated with the second TAG when transmitting a first random access message.

For example, the UE may apply the TAC to the first TAG based at least in part on the first TAG being associated with the NBI-RS set to which the selected SSB belongs. The SSB may belong to the NBI-RS set based at least in part on being received on a beam within the NBI-RS set.

In some aspects, the UE may apply the TAC to the first TAG based at least in part on the BFR procedure being not triggered for a BFD-RS set associated with the first TAG. For example, the UE may apply the TAC to the first TAG based at least in part on the BFR procedure being triggered for a BFD-RS set associated with the second TAG.

In some aspects, the UE may apply the TAC to the first TAG based at least in part on a same CORESET pool index being associated with the first TAG and an SSB associated with the first random access message, or the first TAG being associated with the SSB associated with the first random access message.

Particular aspects of the subject matter described in this disclosure can be implemented to realize one or more of the following potential advantages. In some examples, the described techniques can be used to synchronize, between the UE and the network node, application of a TAC to one of multiple TAGs, where the TAGs are associated with different TRPs or wireless links of a serving cell. In this way, the UE may apply the TAC to an intended TAG (for example, intended by the network node) for configuring timing of communications using the intended TAG and an associated communication link or beam. Based at least in part on applying the TAC to the intended TAG, the UE and the network node may have improved timing synchronization, reduced error rates, and improved spectral efficiency. In this way, the UE and the network node may conserve power, computing, network, and communication resources that may have otherwise been used to detect and correct errors associated with applying the TAC to an unintended TAG.

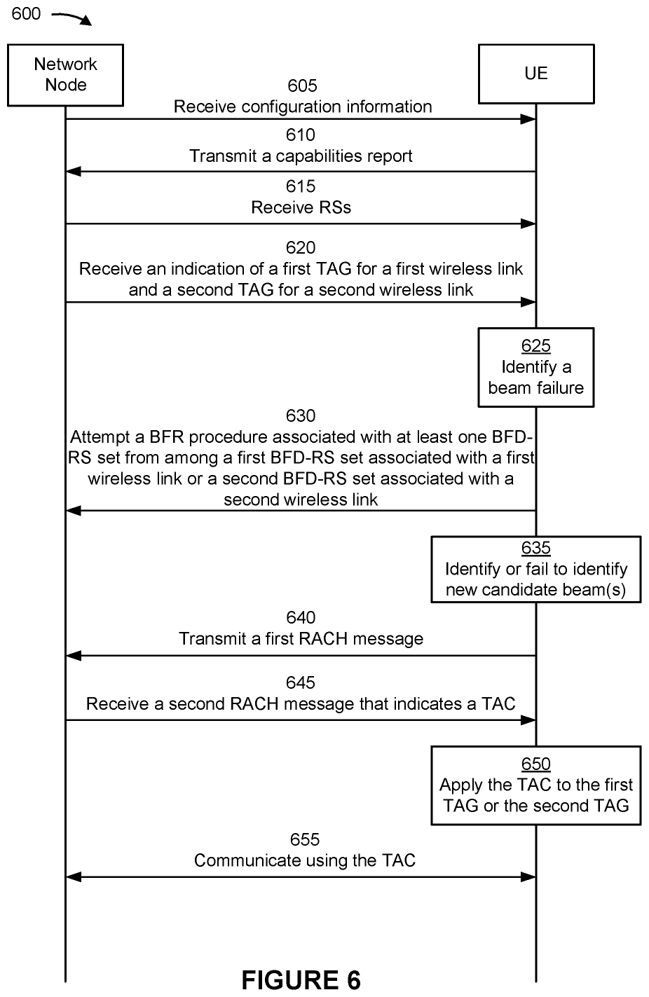

FIG. 6 is a diagram of an example 600 associated with application of TACs of an access channel message to a TAG of multiple TAGs, in accordance with the present disclosure. As shown in FIG. 6, a network node (for example, network node 110, a CU, a DU, or an RU) may communicate with a UE (for example, UE 120). In some aspects, the network node and the UE may be part of a wireless network (for example, wireless network 100). The UE and the network node may have established a wireless connection prior to operations shown in FIG. 6.

As shown in a first operation 605, the network node may transmit, and the UE may receive, configuration information. In some aspects, the UE may receive the configuration information via one or more of RRC signaling, one or more MAC CEs, or downlink control information (DCI), among other examples. In some aspects, the configuration information may include an indication of one or more configuration parameters (for example, already known to the UE or previously indicated by the network node or other network device) for selection by the UE, or explicit configuration information for the UE to use to configure the UE, among other examples.

In some aspects, the configuration information may indicate that the UE is to transmit an indication of a capability to select a TAG, in a multi-TAG communication scheme, to which the UE is to apply a TAC received during a random access procedure. In some aspects, the configuration information may indicate one or more operations or rules for the UE to select the TAG to which the UE is to apply the TAC received during the random access procedure.

The UE may configure itself based at least in part on the configuration information. In some aspects, the UE may be configured to perform one or more operations described herein based at least in part on the configuration information.

As shown in a second operation 610, the UE may transmit, and the network node may receive, a capabilities report. In some aspects, the capabilities report may indicate UE support for selecting a TAG, in the multi-TAG communication scheme, to which the UE is to apply a TAC received during a random access procedure.

As shown in a third operation 615, the UE may receive, and the network node may transmit, RSs. The RSs may be associated with time synchronization. For example, the RSs may include channel state information reference signals (CSI-RSs) or tracking reference signals (TRSs) that the UE may measure to determine timing information. For example, the timing information may include information associated with propagation delay or a timing advance (TA).

As shown in a fifth operation 620, the UE may receive, and the network node may transmit, an indication of a first TAG for a first wireless link and a second TAG for a second wireless link. The first wireless link may be associated with a first TRP and a first CORESET. The second wireless link may be associated with a second TRP and a second CORESET. The first TAG and the second TAG may be nodes of a serving cell.

In some aspects, the first TAG may be associated with a first NBI-RS set or a first BFD-RS set and the second TAG may be associated with a second NBI-RS set or a second BFD-RS set. In some aspects, the association of a TAG to an NBI-RS set or a BFD-RS set may be based at least in part on the TAG and the NBI-RS set or the BFD-RS set being associated with a same CORESET pool index value. In some aspects, the association of a TAG to an NBI-RS set or a BFD-RS set may be based at least in part on a mapping rule (for example, in a communication protocol or RRC configuration, among other examples), or the first TAG being configured for the first NBI-RS set or the first BFD-RS set.

In some aspects, the first TAG may be configured for the first NBI-RS set or in the first BFD-RS set based at least in part on a configuration of a TAG identification of the first TAG to the first NBI-RS set or the first BFD-RS set or to each RS of the first NBI-RS set or the first BFD-RS set.

As shown in a sixth operation 625, the UE may identify a beam failure. For example, the UE may identify a beam failure for the first wireless link, first TRP, and first CORESET pool index. Additionally or alternatively, the UE may identify a beam failure for the second wireless link, second TRP, and second CORESET pool index.

As shown in a seventh operation 630, the UE may attempt a BFR procedure associated with at least one BFD-RS set from among a first BFD-RS set associated with the first wireless link or a second BFD-RS set associated with the second wireless link. For example, the UE may trigger the BFR procedure and determine if resources allow the UE to transmit the PUCCH_BFRO, as described in connection with FIG. 4.

In some aspects, the BFR procedure may be associated with at least one BFD-RS set from among a first BFD-RS set associated with the first wireless link or a second BFD-RS set associated with the second wireless link.

As shown in an eighth operation 635, the UE may identify or fail to identify one or more new candidate beams. For example, the UE may identify one or more new candidate beams for one BFD-RS set, both BFD-RS sets, or neither BFD-RS set.

As shown in a ninth operation 640, the UE may transmit, and the network node may receive, a first RACH message. In some aspects, the UE may transmit the first RACH message on the serving cell based at least in part on a failure of the BFR procedure.

As shown in a tenth operation 645, the UE may receive, and the network node may transmit, a second RACH message that indicates a TAC. The TAC may be associated with the serving cell that is associated with the first TRP and the second TRP.

As shown in an eleventh operation 650, the UE may apply the TAC to the first TAG or the second TAG.

In some aspects (for example, where the UE fails to identify any new candidate beams before transmission of the first RACH message), the UE may apply the TAC to the first TAG based at least in part on failing to identify, before the transmission of the first RACH message, the new candidate beam for any NBI-RS set and based at least in part on the first TAG being a default TAG. In some aspects, the first TAG may be a default TAG based at least in part on the first TAG being associated with a first TAG that is associated with a first TAG index, a lowest TAG identity relative to a second TAG identity associated with the second TAG, or a default CORESET pool index, among other examples.

In some aspects (for example, where the UE identifies a new candidate beam for an NBI-RS set before transmission of the first RACH message), the UE may apply the TAC to the first TAG based at least in part on the first TAG being associated with the NBI-RS set.

In some aspects (for example, where the UE identifies a first new candidate beam for a first NBI-RS set and a second new candidate beam for a second NBI-RS set before transmission of the first RACH message), the UE may apply the TAC to the first TAG based at least in part on selecting an SSB associated with the first set of new candidate beams (for example, a single first new candidate beam), and the first TAG being associated with the first NBI-RS set. In some aspects, the UE may signal the selection of the SSB to the network node (for example, within the first RACH message).

In some aspects (for example, where the application of the TAC is based at least in part on a BFD-RS set of the first BFD-RS set or the second BFD-RS set, that is not the at least one BFD-RS set, for which the BFR procedure is not triggered), the UE may apply the TAC to the first TAG based at least in part on the BFD-RS set, associated with the first TAG, not being not associated with a BFR procedure.

In some aspects (for example, where the application of the TAC to the first TAG or the second TAG is based at least in part on the SSB associated with the first RACH message), the UE may apply the TAC to the first TAG based at least in part on the first TAG and the SSB associated with the first RACH both being associated with a same CORESET pool index, or the first TAG being associated with the SSB associated with the first random access message. The CORESET pool index may be further associated with the first TRP and the first wireless link.

As shown in a twelfth operation 655, the UE and the network node may communicate using the TAC. For example, the UE may communicate with the serving cell associated with the network node based at least in part on application of the TAC to the first TAG or the second TAG. The application of the TAC to the first TAG or the second TAG may be based at least in part on whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message, among other examples.

Based at least in part on applying the TAC to the intended TAG, the UE and the network node may have improved timing synchronization, reduced error rates, and improved spectral efficiency. In this way, the UE and the network node may conserve power, computing, network, and communication resources that may have otherwise been used to detect and correct errors associated with applying the TAC to an unintended TAG.

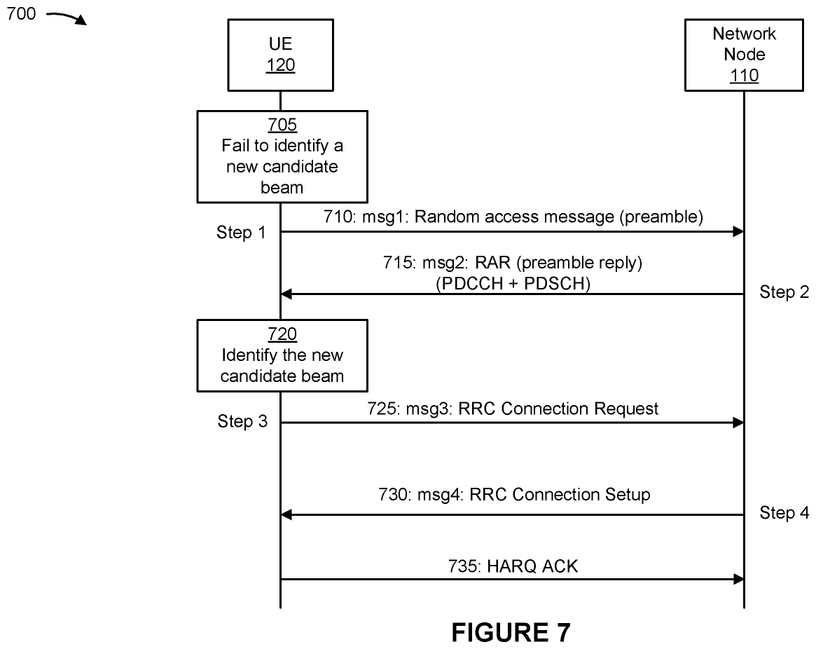

FIG. 7 is a diagram illustrating an example 700 of a four-step random access procedure, in accordance with the present disclosure. As shown in FIG. 7, a network node 110 and a UE 120 may communicate with one another to perform the four-step random access procedure.

As shown in a first operation 705, the UE 120 may fail to identify a new candidate beam before transmitting a first random access message.

As shown in a second operation 710, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a third operation 715, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fourth operation 720, the UE 120 may identify the new candidate beam after receiving the RAR. In some aspects, based at least in part on not identifying any new candidate beams for any NBI-RS sets when the msg1 is transmitted, a TAC in the RAR may correspond to a fixed or configured TAG. For example, the TAC may apply to a first TAG of the serving cell (for example, a SpCell), a lowest TAG identifier of the serving cell, or a TAG associated with CORESETPoolIndex 0.

As shown in a fifth operation 725, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate, for each TRP (for example, a first TRP and a second TRP) a failed BFR set identifier, an NBI existence, or an NBI.

As shown in a sixth operation 730, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a seventh operation 735, if the UE 120 successfully receives the RRC connection setup message, the UE 120 may transmit a HARQ ACK.

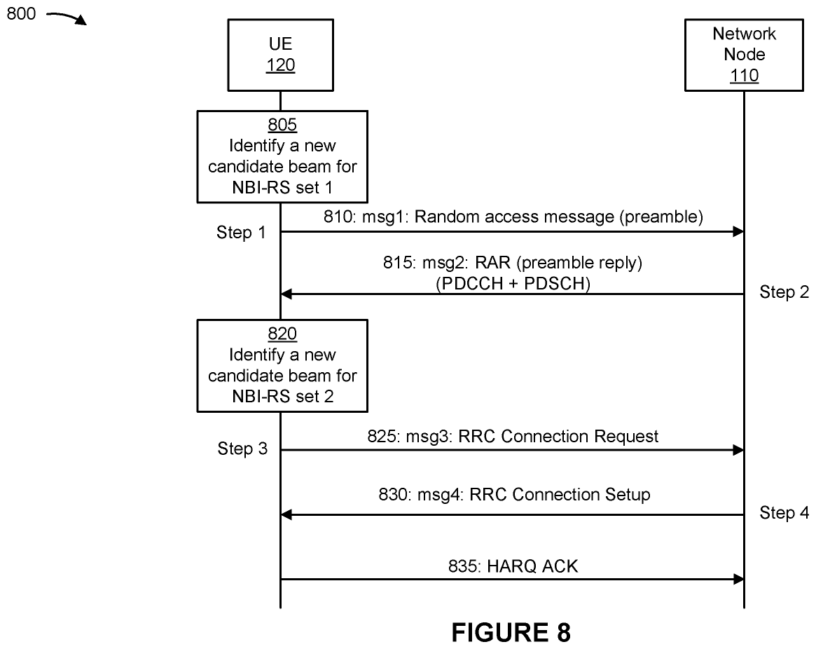

FIG. 8 is a diagram illustrating an example 800 of a four-step random access procedure, in accordance with the present disclosure. As shown in FIG. 8, a network node 110 and a UE 120 may communicate with one another to perform the four-step random access procedure.

As shown in a first operation 805, the UE 120 may identify a new candidate beam for a first NBI-RS set before transmitting a first random access message.

As shown in a second operation 810, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a third operation 815, the network node 110 may transmit an RAR as a reply to the preamble. The message that includes the RAR may be referred to as message 2, msg2, MSG2, or a second message in a four-step random access procedure.

In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fourth operation 820, the UE 120 may identify a new candidate beam for NBI-RS set 2 after receiving the RAR. In some aspects, based at least in part on identifying the new candidate beams for a first NBI-RS set before the msg1 is transmitted, a TAC in the RAR may correspond to a TAG associated with the first NBI-RS set.

In some aspects, the first TAG may be associated with the first NBI-RS set based at least in part on a CORESET pool index (for example, a CORESETPoolIndex value). For example, the first TAG may be associated with the first NBI-RS set based at least in part on the first TAG and the first NBI-RS being associated with a first CORESET pool index value (for example, CORESETPoolIndex_0) or the second TAG and a second NBI-RS being associated with a second CORESET pool index value (for example, CORESETPoolIndex_1).

In some aspects, the first TAG may be associated with the first NBI-RS set based at least in part on a rule. For example the first TAG may be associated with the first NBI-RS set and the second TAG may be associated with the second NBI-RS set based at least in part on a rule in a communication protocol or RRC configuration. In some aspects, a TAG identifier may be configured for each NBI-RS set or a TAG identifier may be configured for each RS in an NBI-RS set. For example, the NBI-RS set may be associated with the TAG ID that is associated with RSs in the NBI-RS set.

As shown in a fifth operation 825, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate, for each TRP (for example, a first TRP and a second TRP) a failed BFR set identifier, an NBI existence, or an NBI.

As shown in a sixth operation 830, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a seventh operation 835, if the UE 120 successfully receives the RRC connection setup message, the UE 120 may transmit a HARQ ACK.

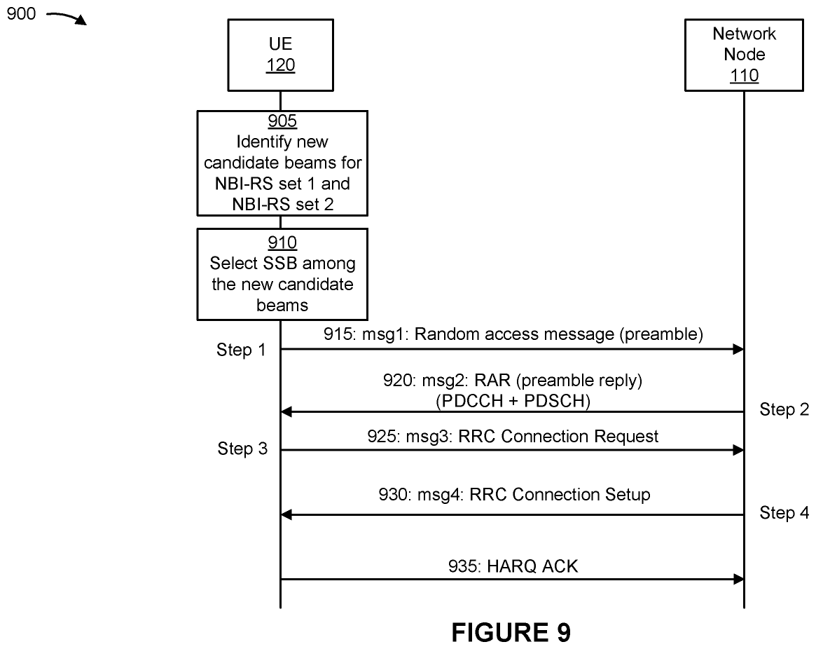

FIG. 9 is a diagram illustrating an example 900 of a four-step random access procedure, in accordance with the present disclosure. As shown in FIG. 9, a network node 110 and a UE 120 may communicate with one another to perform the four-step random access procedure.

As shown in a first operation 905, the UE 120 may identify a new candidate beam for a first NBI-RS set and a new candidate beam for a second NBI-RS set before transmitting a first random access message.

As shown in a second operation 910, the UE may select an SSB among the new candidate beams. In some aspects, the new candidate beams are associated with SSBs having RSRPs that satisfy an RSRP threshold (for example, rsrp-ThresholdSSB), SSBs associated with the new candidate beams may have higher RSRPs than SSBs outside of the new candidate beams. In some aspects, the TAC in the RAR corresponds to a TAG associated with the first NBI-RS set or the second NBI-RS set to which the selected SSB belongs. In some aspects, the TAGs may be associated with the NBI-RS sets based at least in part on, for example, one or more bases described herein.

As shown in a third operation 915, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a fourth operation 920, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fifth operation 925, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate, for each TRP (for example, a first TRP and a second TRP) a failed BFR set identifier, an NBI existence, or an NBI.

As shown in a sixth operation 930, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a seventh operation 935, if the UE 120 successfully receives the RRC connection setup message, the UE 120 may transmit a HARQ ACK.

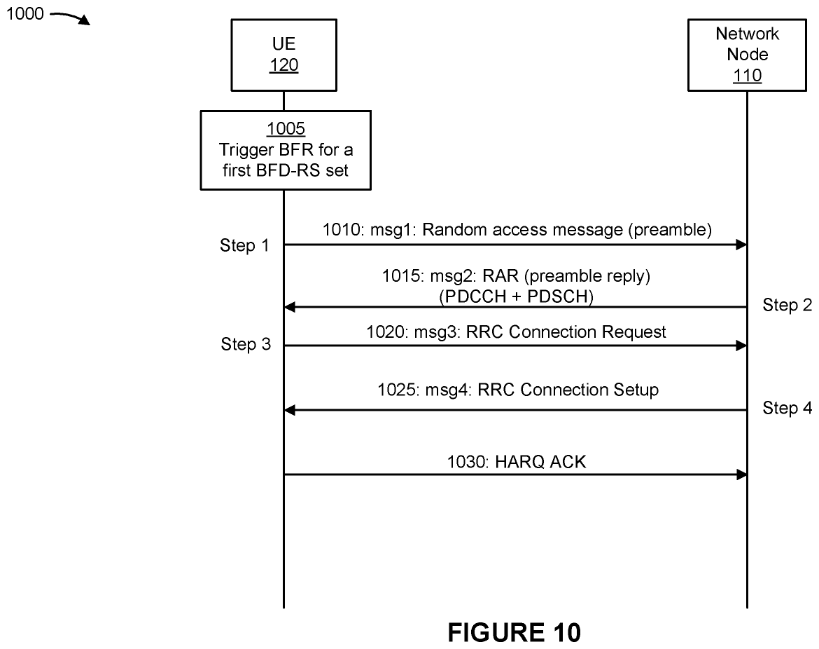

FIG. 10 is a diagram illustrating an example 1000 of a four-step random access procedure, in accordance with the present disclosure. As shown in FIG. 10, a network node 110 and a UE 120 may communicate with one another to perform the four-step random access procedure.

As shown in a first operation 1005, the UE 120 may trigger a BFR process for a first BFD-RS set. For example, the UE may trigger a CBRA and the BFR process may be triggered for one BFD-RS set of the serving cell. In this case, the TAC in the RAR may correspond to a TAG associated with a non-failed BFD-RS set. For example, the UE may trigger a BFR process for a second wireless link associated with a second TAG. In this case, the TAC may be applied to a first TAG associated with a first wireless link for which the BFR process was not triggered.

In some aspects, the association between a TAG and a BFD-RS set can be determined based on the association between a TAG and a NBI-RS set and the association between the BFD-RS set and the NBI-RS set. In some aspects, an association between a TAG and a BFD-RS set may be defined based at least in part on a rule or configuration. In some aspects, the first TAG may be associated with the first BFD-RS set based at least in part on a CORESET pool index (for example, a CORESETPoolIndex value). For example, the first TAG may be associated with the first BFD-RS set based at least in part on the first TAG and the first BFD-RS being associated with a first CORESET pool index value (for example, CORESETPoolIndex_0) or the second TAG and a second BFD-RS being associated with a second CORESET pool index value (for example, CORESETPoolIndex_1).

For example, the first TAG may be associated with the first BFD-RS set based at least in part on a rule. For example, the first TAG may be associated with the first BFD-RS set and the second TAG may be associated with the second BFD-RS set based at least in part on a rule in a communication protocol or RRC configuration. In some aspects, a TAG identifier may be configured for each BFD-RS set or a TAG identifier may be configured for each RS in an BFD-RS set. For example, the BFD-RS set may be associated with the TAG ID that is associated with RSs in the BFD-RS set.

As shown in a second operation 1010, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a third operation 1015, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fourth operation 1020, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate, for each TRP (for example, a first TRP and a second TRP) a failed BFR set identifier, an NBI existence, or an NBI.

As shown in a fifth operation 1025, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a sixth operation 1030, if the UE 120 successfully receives the RRC connection setup message, the UE 120 may transmit a HARQ ACK.

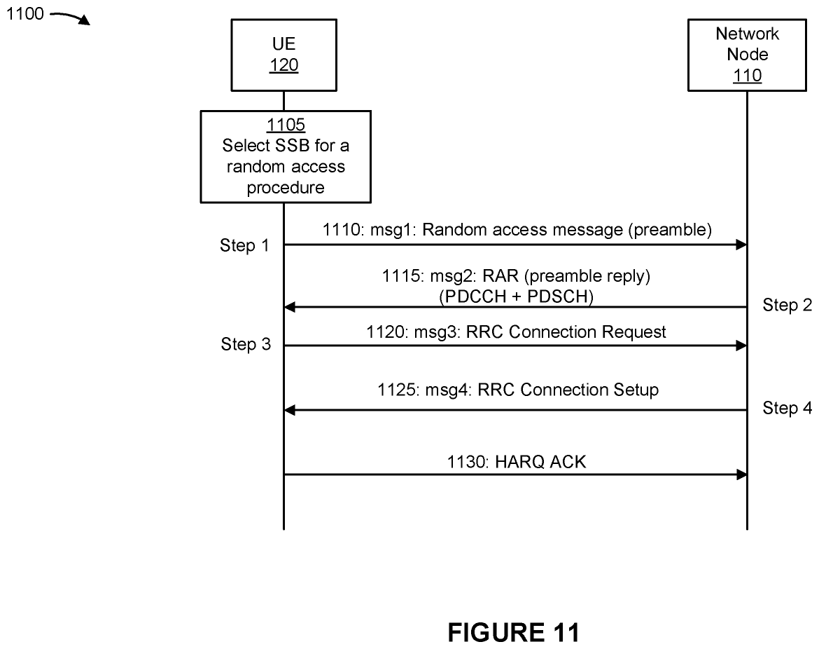

FIG. 11 is a diagram illustrating an example 1100 of a four-step random access procedure, in accordance with the present disclosure. As shown in FIG. 11, a network node 110 and a UE 120 may communicate with one another to perform the four-step random access procedure.

As shown in a first operation 1105, the UE 120 may select an SSB for a random access procedure. The UE may trigger the random access procedure based at least in part on failure of a BFR procedure or time alignment timer expiration, among other examples. In some aspects, a TAC in the RAR may correspond to the first TAG based at least in part on the first TAG being associated with the SSB selected for the random access procedure.

For example, the TAC in the RAR may correspond to the first TAG based at least in part on being associated with a same CORESET pool index as the selected SSB for CBRA. In some aspects, the TAC in the RAR corresponds to the first TAG based at least in part on being associated with the selected SSB (for example, if TAG IDs are associated or configured for each SSB).

As shown in a second operation 1110, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown in a third operation 1115, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (for example, received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication. The RAR may include an indication of a TAC for subsequent communications.

As shown in a fourth operation 1120, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (for example, an RRC connection request). The RRC connection request may include indices of component carriers that include a failed TRP link. In some examples, the RRC connection request may indicate, for each TRP (for example, a first TRP and a second TRP) a failed BFR set identifier, an NBI existence, or an NBI.

As shown in a fifth operation 1125, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by a sixth operation 1130, if the UE 120 successfully receives the RRC connection setup message, the UE 120 may transmit a HARQ ACK.

FIG. 12 is a flowchart illustrating an example process 1200 performed, for example, by a UE that supports selection of a TAG, in a multi-TAG communication scheme, to which the UE is to apply a TAC received during a random access procedure in accordance with the present disclosure. Example process 1200 is an example where the UE (for example, UE 120) performs operations associated with application of TACs of an access channel message to a TAG of multiple TAGs.

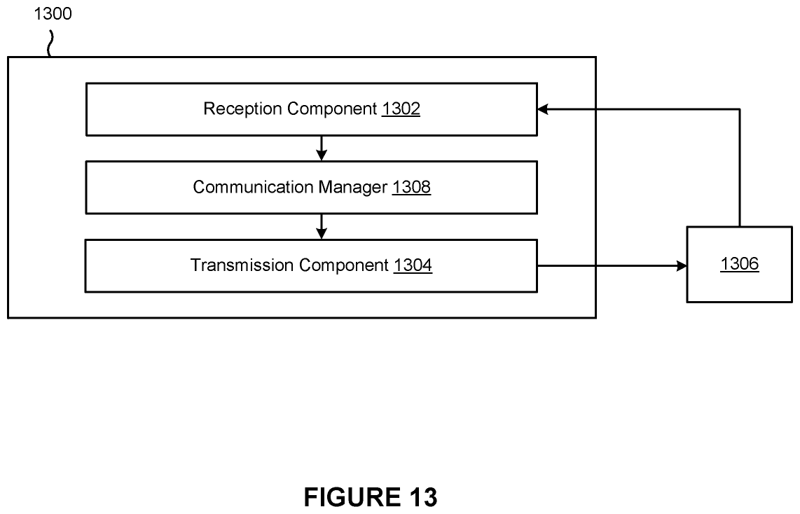

As shown in FIG. 12, in some aspects, process 1200 may include receiving an indication of a first TAG associated with a first wireless link and a second TAG associated with a second wireless link for a serving cell (block 1210). For example, the UE (such as by using communication manager 140 or reception component 1302, depicted in FIG. 13) may receive an indication of a first TAG associated with a first wireless link and a second TAG associated with a second wireless link for a serving cell, as described above.

As further shown in FIG. 12, in some aspects, process 1200 may include transmitting a first random access channel (RACH) message on the serving cell based at least in part on a failure of a BFR procedure associated with at least one BFD-RS set from among a first BFD-RS set associated with the first wireless link or a second BFD-RS set associated with the second wireless link (block 1220). For example, the UE (such as by using communication manager 140 or transmission component 1304, depicted in FIG. 13) may transmit a first random access channel (RACH) message on the serving cell based at least in part on a failure of a BFR procedure associated with at least one BFD-RS set from among a first BFD-RS set associated with the first wireless link or a second BFD-RS set associated with the second wireless link, as described above.

As further shown in FIG. 12, in some aspects, process 1200 may include receiving, based at least in part on transmitting the first RACH message, a second RACH message that indicates a TAC for the serving cell (block 1230). For example, the UE (such as by using communication manager 140 or reception component 1302, depicted in FIG. 13) may receive, based at least in part on transmitting the first RACH message, a second RACH message that indicates a TAC for the serving cell, as described above.

As further shown in FIG. 12, in some aspects, process 1200 may include communicating, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message (block 1240). For example, the UE (such as by using communication manager 140, receiving component 1302, or transmission component 1304, depicted in FIG. 13) may communicate, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message, as described above.

Process 1200 may include additional aspects, such as any single aspect or any combination of aspects described below or in connection with one or more other processes described elsewhere herein.

In a first additional aspect, the first TAG is associated with a new beam identification RS (NBI-RS) set or the first BFD-RS set based at least in part on one or more of the first TAG and at least one of the NBI-RS set or the first BFD-RS set being associated with a same CORESET pool index value, a mapping rule, or the first TAG being configured for the NBI-RS set or the first BFD-RS set.

In a second additional aspect, alone or in combination with the first aspect, the first TAG is configured for the first NBI-RS set or in the first BFD-RS set based at least in part on a configuration of a TAG identification of the first TAG to the first NBI-RS set or the first BFD-RS set, or each RS of the first NBI-RS set or the first BFD-RS set.

In a third additional aspect, alone or in combination with one or more of the first and second aspects, process 1200 includes failing to identify, before the transmission of the first RACH message, the new candidate beam for any NBI-RS set, wherein the application of the TAC to the first TAG or the second TAG is based at least in part on whether the new candidate beam is identified before the transmission of the first RACH message, and wherein the application of the TAC to the first TAG is based at least in part on the first TAG being a default TAG.

In a fourth additional aspect, alone or in combination with one or more of the first through third aspects, the first TAG is a default TAG based at least in part on the first TAG being associated with a first TAG that is associated with a first TAG index, a lowest TAG identity relative to a second TAG identity associated with the second TAG, or a default CORESET pool index.

In a fifth additional aspect, alone or in combination with one or more of the first through fourth aspects, process 1200 includes identifying, before the transmission of the first RACH message, the new candidate beam for a NBI-RS set, wherein the application of the TAC to the first TAG or the second TAG is based at least in part on whether the new candidate beam is identified before the transmission of the first RACH message, and wherein the TAC applies to the first TAG based at least in part on the first TAG being associated with the NBI-RS set.

In a sixth additional aspect, alone or in combination with one or more of the first through fifth aspects, process 1200 includes identifying, before the transmission of the first RACH message, a first set of new candidate beams for a first NBI-RS set and a second set of new candidate beams for a second NBI-RS set, and selecting a SSB associated with the first set of new candidate beams or the second set of new candidate beams, wherein the application of the TAC to the first TAG or the second TAG is based at least in part on whether the new candidate beam is identified before transmitting the first RACH message, and wherein the TAC applies to the first TAG based at least in part on the selected SSB being within the first set of candidate beams and the first TAG being associated with the first NBI-RS set.

In a seventh additional aspect, alone or in combination with one or more of the first through sixth aspects, the application of the TAC to the first TAG or the second TAG is based at least in part on a BFD-RS set of the first BFD-RS set or the second BFD-RS set, that is not the at least one BFD-RS set, for which the BFR procedure is not triggered, wherein the at least one BFD-RS set is associated with the first TAG and the BFD-RS set that is not the at least one BFD-RS set is associated with the second TAG, and wherein the TAC applies to the second TAG based at least in part on the BFD-RS set being associated with the second TAG.

In an eighth additional aspect, alone or in combination with one or more of the first through seventh aspects, the application of the TAC to the first TAG or the second TAG is based at least in part on the SSB associated with the first RACH message, wherein the SSB and the first TAG are associated with a same CORESET pool index, and wherein the TAC applies to the first TAG based at least in part on the SSB and the first TAG being associated with the same CORESET pool index.

In a ninth additional aspect, alone or in combination with one or more of the first through eighth aspects, the application of the TAC to the first TAG or the second TAG is based at least in part on the SSB associated with the first RACH message, wherein the first TAG is associated with the SSB, and wherein the TAC applies to the first TAG based at least in part on the first TAG being associated with the SSB.

In a tenth additional aspect, alone or in combination with one or more of the first through ninth aspects, the first TAG is associated with communications with a first network node, and wherein the second TAG is associated with communications with a second network node.

In an eleventh additional aspect, alone or in combination with one or more of the first through tenth aspects, process 1200 includes identifying a beam failure for the at least one BFD-RS set that triggers the transmission of the first RACH message.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager (for example, the communication manager 140).

In some aspects, the apparatus 1300 may be configured to perform one or more operations described herein in connection with FIGS. 6-11. Additionally, or alternatively, the apparatus 1300 may be configured to perform one or more processes described herein, such as process 1200 of FIG. 12. In some aspects, the apparatus 1300 or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive an indication of a first TAG associated with a first wireless link and a second TAG associated with a second wireless link for a serving cell. The transmission component 1304 may transmit a first random access channel (RACH) message on the serving cell based at least in part on a failure of a BFR procedure associated with at least one BFD-RS set from among a first BFD-RS set associated with the first wireless link or a second BFD-RS set associated with the second wireless link. The reception component 1302 may receive, based at least in part on transmitting the first RACH message, a second RACH message that indicates a TAC for the serving cell. The reception component 1302 or transmission component 1304 may communicate, with the serving cell, based at least in part on application of the TAC to the first TAG or the second TAG, the application of the TAC to the first TAG or the second TAG being based at least in part on one or more of whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a SSB associated with the first RACH message.

The communication manager 1308 may fail to identify, before the transmission of the first RACH message, the new candidate beam for any NBI-RS set wherein the application of the TAC to the first TAG or the second TAG is based at least in part on whether the new candidate beam is identified before the transmission of the first RACH message, and wherein the application of the TAC to the first TAG is based at least in part on the first TAG being a default TAG.

The communication manager 1308 may identify, before the transmission of the first RACH message, the new candidate beam for a NBI-RS set wherein the application of the TAC to the first TAG or the second TAG is based at least in part on whether the new candidate beam is identified before the transmission of the first RACH message, and wherein the TAC applies to the first TAG based at least in part on the first TAG being associated with the NBI-RS set.

The communication manager 1308 may identify, before the transmission of the first RACH message, a first set of new candidate beams for a first NBI-RS set and a second set of new candidate beams for a second NBI-RS set.

The communication manager 1308 may select a SSB associated with the first set of new candidate beams or the second set of new candidate beams wherein the application of the TAC to the first TAG or the second TAG is based at least in part on whether the new candidate beam is identified before transmitting the first RACH message, and wherein the TAC applies to the first TAG based at least in part on the selected SSB being within the first set of candidate beams and the first TAG being associated with the first NBI-RS set.

The communication manager 1308 may identify a beam failure for the at least one BFD-RS set that triggers the transmission of the first RACH message.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a user equipment (UE), comprising: receiving an indication of a first timing advance group (TAG) associated with a first wireless link and a second TAG associated with a second wireless link for a serving cell; transmitting a first random access channel (RACH) message on the serving cell based at least in part on a failure of a beam failure recovery (BFR) procedure associated with at least one beam failure detection (BFD) reference signal (RS) set from among a first BFD-RS set associated with the first wireless link or a second BFD-RS set associated with the second wireless link; receiving, based at least in part on transmitting the first RACH message, a second RACH message that indicates a timing advance command (TAC) for the serving cell; and communicating, with the serving cell, based at least in part on application of the TAC to the first TAG or the second TAG, the application of the TAC to the first TAG or the second TAG being based at least in part on one or more of: whether a new candidate beam, associated with the first wireless link or the second wireless link, is identified before the transmission of the first RACH message, a BFD-RS set of the first BFD-RS set or the second BFD-RS set, that is not the at least one BFD-RS set, for which the BFR procedure is not triggered, or a synchronization signal block (SSB) associated with the first RACH message.
Aspect 2: The method of Aspect 1, wherein the first TAG is associated with a new beam identification RS (NBI-RS) set or the first BFD-RS set based at least in part on one or more of: the first TAG and at least one of the NBI-RS set or the first BFD-RS set being associated with a same control resource set (CORESET) pool index value, a mapping rule, or the first TAG being configured for the NBI-RS set or the first BFD-RS set.
Aspect 3: The method of Aspect 2, wherein the first TAG is configured for the first NBI-RS set or in the first BFD-RS set based at least in part on a configuration of a TAG identification of the first TAG to: the first NBI-RS set or the first BFD-RS set, or each RS of the first NBI-RS set or the first BFD-RS set.
Aspect 4: The method of any of Aspects 1-3, further comprising failing to identify, before the transmission of the first RACH message, the new candidate beam for any new beam identification RS (NBI-RS) set, wherein the application of the TAC to the first TAG or the second TAG is based at least in part on whether the new candidate beam is identified before the transmission of the first RACH message, and wherein the application of the TAC to the first TAG is based at least in part on the first TAG being a default TAG.
Aspect 5: The method of Aspect 4, wherein the first TAG is a default TAG based at least in part on the first TAG being associated with: a first TAG that is associated with a first TAG index, a lowest TAG identity relative to a second TAG identity associated with the second TAG, or a default control resource set (CORESET) pool index.
Aspect 6: The method of any of Aspects 1-5, further comprising identifying, before the transmission of the first RACH message, the new candidate beam for a new beam identification RS (NBI-RS) set, wherein the application of the TAC to the first TAG or the second TAG is based at least in part on whether the new candidate beam is identified before the transmission of the first RACH message, and wherein the TAC applies to the first TAG based at least in part on the first TAG being associated with the NBI-RS set.
Aspect 7: The method of any of Aspects 1-6, further comprising: identifying, before the transmission of the first RACH message, a first set of new candidate beams for a first new beam identification RS (NBI-RS) set and a second set of new candidate beams for a second NBI-RS set; and selecting a synchronization signal block (SSB) associated with the first set of new candidate beams or the second set of new candidate beams, wherein the application of the TAC to the first TAG or the second TAG is based at least in part on whether the new candidate beam is identified before transmitting the first RACH message, and wherein the TAC applies to the first TAG based at least in part on the selected SSB being within the first set of candidate beams and the first TAG being associated with the first NBI-RS set.
Aspect 8: The method of any of Aspects 1-7, wherein the application of the TAC to the first TAG or the second TAG is based at least in part on a BFD-RS set of the first BFD-RS set or the second BFD-RS set, that is not the at least one BFD-RS set, for which the BFR procedure is not triggered, wherein the at least one BFD-RS set is associated with the first TAG and the BFD-RS set that is not the at least one BFD-RS set is associated with the second TAG, and wherein the TAC applies to the second TAG based at least in part on the BFD-RS set being associated with the second TAG.
Aspect 9: The method of any of Aspects 1-8, wherein the application of the TAC to the first TAG or the second TAG is based at least in part on the SSB associated with the first RACH message, wherein the SSB and the first TAG are associated with a same control resource set (CORESET) pool index, and wherein the TAC applies to the first TAG based at least in part on the SSB and the first TAG being associated with the same CORESET pool index.
Aspect 10: The method of any of Aspects 1-9, wherein the application of the TAC to the first TAG or the second TAG is based at least in part on the SSB associated with the first RACH message, wherein the first TAG is associated with the SSB, and wherein the TAC applies to the first TAG based at least in part on the first TAG being associated with the SSB.
Aspect 11: The method of any of Aspects 1-10, wherein the first TAG is associated with communications with a first network node, and wherein the second TAG is associated with communications with a second network node.
Aspect 12: The method of any of Aspects 1-11, further comprising identifying a beam failure for the at least one BFD-RS set that triggers the transmission of the first RACH message.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
a memory; and
one or more processors, coupled to the memory, configured to:
receive an indication of a first timing advance group (TAG) associated with a first wireless link and a second TAG associated with a second wireless link for a serving cell;
transmit a first random access channel (RACH) message on the serving cell based at least in part on a failure of a beam failure recovery (BFR) procedure associated with at least one beam failure detection (BFD) reference signal (RS) set from among a first BFD-RS set associated with the first wireless link or a second BFD-RS set associated with the second wireless link;
receive, based at least in part on transmitting the first RACH message, a second RACH message that indicates a timing advance command (TAC) for the serving cell; and
communicate, with the serving cell, based at least in part on application of the TAC to the first TAG or the second TAG, the application of the TAC to the first TAG or the second TAG being based at least in part on one or more of:
whether a new candidate beam, associated with the first wireless link or the second wireless link, is identified before the transmission of the first RACH message,
a BFD-RS set of the first BFD-RS set or the second BFD-RS set, that is not the at least one BFD-RS set, for which the BFR procedure is not triggered, or
a synchronization signal block (SSB) associated with the first RACH message.

2. The UE of claim 1, wherein the first TAG is associated with a new beam identification RS (NBI-RS) set or the first BFD-RS set based at least in part on one or more of:
the first TAG and at least one of the NBI-RS set or the first BFD-RS set being associated with a same control resource set (CORESET) pool index value,
a mapping rule, or
the first TAG being configured for the NBI-RS set or the first BFD-RS set.

3. The UE of claim 2, wherein the first TAG is configured for the first NBI-RS set or in the first BFD-RS set based at least in part on a configuration of a TAG identification of the first TAG to:
the first NBI-RS set or the first BFD-RS set, or
each RS of the first NBI-RS set or the first BFD-RS set.

4. The UE of claim 1, wherein the one or more processors are further configured to fail to identify, before the transmission of the first RACH message, the new candidate beam for any new beam identification RS (NBI-RS) set,
wherein the application of the TAC to the first TAG or the second TAG is based at least in part on whether the new candidate beam is identified before the transmission of the first RACH message, and
wherein the application of the TAC to the first TAG is based at least in part on the first TAG being a default TAG.

5. The UE of claim 4, wherein the first TAG is a default TAG based at least in part on the first TAG being associated with:
a first TAG that is associated with a first TAG index,
a lowest TAG identity relative to a second TAG identity associated with the second TAG, or
a default control resource set (CORESET) pool index.

6. The UE of claim 1, wherein the one or more processors are further configured to identify, before the transmission of the first RACH message, the new candidate beam for a new beam identification RS (NBI-RS) set,
wherein the application of the TAC to the first TAG or the second TAG is based at least in part on whether the new candidate beam is identified before the transmission of the first RACH message, and
wherein the TAC applies to the first TAG based at least in part on the first TAG being associated with the NBI-RS set.

7. The UE of claim 1, wherein the one or more processors are further configured to:
identify, before the transmission of the first RACH message, a first set of new candidate beams for a first new beam identification RS (NBI-RS) set and a second set of new candidate beams for a second NBI-RS set; and
select a synchronization signal block (SSB) associated with the first set of new candidate beams or the second set of new candidate beams,
wherein the application of the TAC to the first TAG or the second TAG is based at least in part on whether the new candidate beam is identified before transmitting the first RACH message, and
wherein the TAC applies to the first TAG based at least in part on the selected SSB being within the first set of candidate beams and the first TAG being associated with the first NBI-RS set.

8. The UE of claim 1, wherein the application of the TAC to the first TAG or the second TAG is based at least in part on a BFD-RS set of the first BFD-RS set or the second BFD-RS set, that is not the at least one BFD-RS set, for which the BFR procedure is not triggered,
wherein the at least one BFD-RS set is associated with the first TAG and the BFD-RS set that is not the at least one BFD-RS set is associated with the second TAG, and
wherein the TAC applies to the second TAG based at least in part on the BFD-RS set being associated with the second TAG.

9. The UE of claim 1, wherein the application of the TAC to the first TAG or the second TAG is based at least in part on the SSB associated with the first RACH message,
wherein the SSB and the first TAG are associated with a same control resource set (CORESET) pool index, and
wherein the TAC applies to the first TAG based at least in part on the SSB and the first TAG being associated with the same CORESET pool index.

10. The UE of claim 1, wherein the application of the TAC to the first TAG or the second TAG is based at least in part on the SSB associated with the first RACH message,
wherein the first TAG is associated with the SSB, and
wherein the TAC applies to the first TAG based at least in part on the first TAG being associated with the SSB.

11. The UE of claim 1, wherein the first TAG is associated with communications with a first network node, and wherein the second TAG is associated with
communications with a second network node.

12. The UE of claim 1, wherein the one or more processors are further configured to identify a beam failure for the at least one BFD-RS set that triggers the transmission of the first RACH message.

13. A method of wireless communication performed by a user equipment (UE), comprising:
receiving an indication of a first timing advance group (TAG) associated with a first wireless link and a second TAG associated with a second wireless link for a serving cell;
transmitting a first random access channel (RACH) message on the serving cell based at least in part on a failure of a beam failure recovery (BFR) procedure associated with at least one beam failure detection (BFD) reference signal (RS) set from among a first BFD-RS set associated with the first wireless link or a second BFD-RS set associated with the second wireless link;
receiving, based at least in part on transmitting the first RACH message, a second RACH message that indicates a timing advance command (TAC) for the serving cell; and
communicating, with the serving cell, based at least in part on application of the TAC to the first TAG or the second TAG, the application of the TAC to the first TAG or the second TAG being based at least in part on one or more of:
whether a new candidate beam, associated with the first wireless link or the second wireless link, is identified before the transmission of the first RACH message,
a BFD-RS set of the first BFD-RS set or the second BFD-RS set, that is not the at least one BFD-RS set, for which the BFR procedure is not triggered, or
a synchronization signal block (SSB) associated with the first RACH message.

14. The method of claim 13, wherein the first TAG is associated with a new beam identification RS (NBI-RS) set or the first BFD-RS set based at least in part on one or more of:
the first TAG and at least one of the NBI-RS set or the first BFD-RS set being associated with a same control resource set (CORESET) pool index value,
a mapping rule, or
the first TAG being configured for the NBI-RS set or the first BFD-RS set.

15. The method of claim 14, wherein the first TAG is configured for the first NBI-RS set or in the first BFD-RS set based at least in part on a configuration of a TAG identification of the first TAG to:
the first NBI-RS set or the first BFD-RS set, or
each RS of the first NBI-RS set or the first BFD-RS set.

16. The method of claim 13, further comprising failing to identify, before the transmission of the first RACH message, the new candidate beam for any new beam identification RS (NBI-RS) set,
wherein the application of the TAC to the first TAG or the second TAG is based at least in part on whether the new candidate beam is identified before the transmission of the first RACH message, and
wherein the application of the TAC to the first TAG is based at least in part on the first TAG being a default TAG.

17. The method of claim 16, wherein the first TAG is a default TAG based at least in part on the first TAG being associated with:
a first TAG that is associated with a first TAG index,
a lowest TAG identity relative to a second TAG identity associated with the second TAG, or
a default control resource set (CORESET) pool index.

18. The method of claim 13, further comprising identifying, before the transmission of the first RACH message, the new candidate beam for a new beam identification RS (NBI-RS) set,
wherein the application of the TAC to the first TAG or the second TAG is based at least in part on whether the new candidate beam is identified before the transmission of the first RACH message, and
wherein the TAC applies to the first TAG based at least in part on the first TAG being associated with the NBI-RS set.

19. The method of claim 13, further comprising:
identifying, before the transmission of the first RACH message, a first set of new candidate beams for a first new beam identification RS (NBI-RS) set and a second set of new candidate beams for a second NBI-RS set; and
selecting a synchronization signal block (SSB) associated with the first set of new candidate beams or the second set of new candidate beams,
wherein the application of the TAC to the first TAG or the second TAG is based at least in part on whether the new candidate beam is identified before transmitting the first RACH message, and
wherein the TAC applies to the first TAG based at least in part on the selected SSB being within the first set of candidate beams and the first TAG being associated with the first NBI-RS set.

20. The method of claim 13, wherein the application of the TAC to the first TAG or the second TAG is based at least in part on a BFD-RS set of the first BFD-RS set or the second BFD-RS set, that is not the at least one BFD-RS set, for which the BFR procedure is not triggered,
wherein the at least one BFD-RS set is associated with the first TAG and the BFD-RS set that is not the at least one BFD-RS set is associated with the second TAG, and
wherein the TAC applies to the second TAG based at least in part on the BFD-RS set being associated with the second TAG.

21-30. (canceled)
